(19) United States
(12) Patent Application Publication
(10) Pub. No.: US 2024/0240348 A1
(43) Pub. Date: Jul. 18, 2024

(54) FRICTION AND GALVANICALLY SACRIFICIAL ANODIC COATINGS AND METHOD OF APPLICATION THEREOF

(71) Applicant: SPS Technologies Limited, Leicester (GB)

(72) Inventors: Michael STEELE, Leicestershire (GB); Giuseppe FERRARA, Leicester (GB); David ABRAHAM, Leicester (GB)

(73) Assignee: SPS Technologies Limited, Leicester (GB)

(21) Appl. No.: 18/413,392

(22) Filed: Jan. 16, 2024

Related U.S. Application Data
(60) Provisional application No. 63/438,809, filed on Jan. 13, 2023.

(51) Int. Cl. C25D 11/06; C25D 11/16; C25D 11/24; F16B 19/04; F16B 19/10

(52) U.S. Cl. CPC C25D 11/06; C25D 11/16; C25D 11/24; F16B 19/1072; F16B 2019/045

(57) ABSTRACT

A method of applying a coating to a substrate includes ionic electrolytic plating a substrate submerged within an ionic liquid at ambient temperature, in ambient air, and at ambient pressure with aluminum. The ionic liquid includes imidazolium chloride compounds having aluminum chloride (AlCl₃) and sodium dodecyl sulphate (C₁₂H₂₅NaO₄S) in a mono ethylene glycol solution, and a deposition rate of the ionic electrolytic plating is controlled by a power supply within a temperature range between about 288 Kelvin (59° F.) to about 305 Kelvin (89° F.).

### CROSS-REFERENCE TO RELATED APPLICATIONS

This application claims priority to and the benefit of U.S. Provisional Application No. 63/438,809, filed on Jan. 13, 2023. The disclosure of the above application is incorporated herein by reference.

### FIELD

The present disclosure relates to friction coatings and galvanically sacrificial anodic coatings for a variety of applications, including by way of example structural blind fasteners for use with aircraft structures.

### BACKGROUND

The statements in this section merely provide background information related to the present disclosure and may not constitute prior art.

In one example application of a friction coating, a blind fastener is typically used to secure structural members together, such as by way of example aircraft skins, and is installed from one side (i.e., an outer moldline side), thereby creating a “blind” fastener installation. The blind fastener typically includes a bolt and a sleeve surrounding the bolt, which are inserted into aligned holes of the structural members. A portion of the sleeve adjacent to a rear side of one of the structural members is deformed during installation of the fastener, thereby forming a “bulb” on the blind side, provided the sleeve does not rotate during installation. The deformed portion of the sleeve provides a bearing surface to induce preload in the fastener such that the structural members can be fastened together in compression. After installation, torque is applied to a drive head of the bolt, which causes it to shear off or separate from the bolt. Thereafter, torque is applied to a drive head of the sleeve, which also causes it to shear off or separate from the sleeve. As a result, a flush installation of the blind fastener is achieved.

During installation of blind fasteners, a sealant is often used between an exterior surface of the sleeve and the structural members to meet a number of application requirements. The introduction of such sealants, however, can reduce the friction between the blind fastener and structural members, allowing the sleeve to rotate in its installed position rather than shear off to complete the installation.

These issues related to the use and installation of structural blind fasteners, among other structural requirements of blind fasteners, are addressed by the present disclosure.

### SUMMARY

This section provides a general summary of the disclosure and is not a comprehensive disclosure of its full scope or all of its features.

In one form of the present disclosure, a method of applying a coating to a substrate comprises ionic electrolytic plating a substrate immersed within an ionic liquid at ambient temperature, in ambient air, and at ambient pressure with aluminum, wherein the ionic liquid comprises imidazolium chloride compounds having aluminum chloride (AlCl₃) and sodium dodecyl sulphate (C₁₂H₂₅NaO₄S) in a mono ethylene glycol solution, and a deposition rate of the ionic electrolytic plating is controlled by a power supply and within a temperature range between about 288 Kelvin (59° F.) to about 305 Kelvin (89° F.).

In variations of this method, which may be implemented individually or in any combination: the aluminum is an anode consisting of 99.99 wt. % aluminum; the aluminum is saturated in the ionic liquid; the power supply comprises an AC to DC twelve pulse rectifier; the ionic liquid comprises: 1-Butyl-3-methylimidazolium chloride ([BMIm]Cl), 1-Ethyl-3-methylimidazolium chloride ([EMIm]Cl) incorporating Aluminum Chloride (AlCl₃), and Sodium dodecyl sulphate (C₁₂H₂₅NaO₄S); an exterior surface of the substrate is roughened prior to the ionic electrolytic plating; laser ablation is used to roughen the exterior surface; the exterior surface is roughened to an Ra of at least 0.4 μm; the substrate is a material selected from the group consisting of stainless steel, steel, aluminum, titanium, alloys thereof, polymers and fiber-reinforced polymers; the substrate is a structural fastener; further passivating the substrate after the ionic electrolytic plating; further adding coloration during or after the ionic electrolytic plating; and a thickness of the ionic plating is between about 5 μm and about 25 μm.

In another form of the present disclosure, a structural blind fastener for joining a plurality of workpieces comprises a sleeve comprising a tool engagement feature disposed at a proximal end portion of the sleeve, a cylindrical outer wall having an exterior surface, the exterior surface comprising a roughened area having an Ra of at least 0.4 μm and a friction coating consisting of 99.99 wt. % Aluminum (Al) applied onto the roughened area according to the method set forth above. A central bore extends along a length of the sleeve, the central bore defining internal threads disposed at a distal end portion of the sleeve, and a bolt includes a shaft extending through the central bore of the sleeve, the shaft comprising external threads disposed at a distal end portion of the bolt, the external threads configured to engage the internal threads of the sleeve, wherein the bolt further comprises a tool engagement feature disposed at a proximal end portion of the bolt.

In yet another form, a structural assembly comprises a plurality of workpieces and a structural blind fastener as set forth above.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a coating system in accordance with the principles of the present disclosure.

FIG. 2 is an exploded perspective view of a structural blind fastener constructed according to the teachings of the present disclosure;

FIG. 3 is a cross-sectional view of a structural assembly having a structural blind fastener in a pre-installation position according to the teachings of the present disclosure;

FIG. 4 is a cross-sectional view of the structural assembly of FIG. 3 with the structural blind fastener in the installed position;

FIG. 5A is a cross-sectional view of a structural assembly having another form of a structural fastener in a pre-installation position according to the teachings of the present disclosure; and

FIG. 5B is a cross-sectional view of the structural assembly of FIG. 5A with the structural fastener in the installed position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

According to the teachings herein, a method of applying a coating using a novel ionic liquid is disclosed, which can be used as a friction coating or a galvanically sacrificial anodic coating for a variety of applications. As used herein, the term “room temperature” should be construed to mean ambient temperature in a range between about 15° C. (59° F.) to about 32° C. (89.6° F.). The method is further carried out in “ambient air,” which should be construed to mean about 78% N₂, 21% O₂, and a balance trace gases, and at “ambient pressure,” which should be construed to mean the standard pressure in the location where the method is being carried out, or acting on the RTIL, in which a substrate is immersed.

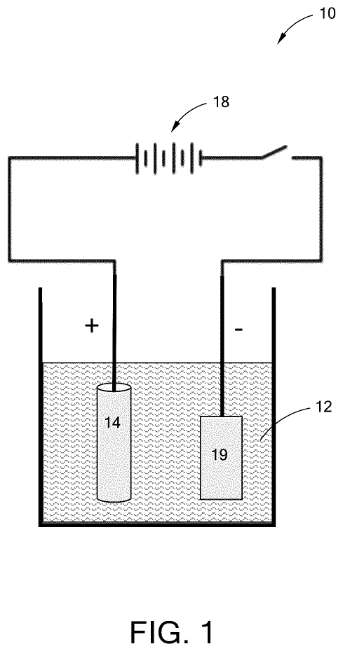

Referring to FIG. 1, the general arrangement of an ionic electrolytic plating system 10 is illustrated. The ionic electrolytic plating system 10 includes an ionic liquid 12 contained within a vessel 14, an anode 16, a power supply 18, and a substrate 19 to be coated. It should be understood that the substrate 19 may be any material (specific examples are provided in greater detail below), including but not limited to stainless steel, steel, aluminum, titanium, alloys thereof, polymers and fiber-reinforced polymers such as carbon fiber reinforced polymers (CFRPs). Further, the substrate 19 may be any of a variety of components, including by way of example, fasteners (described in greater detail below), clamps, collets, and belts, among others.

The ionic liquid 12 generally comprises imidazolium chloride compounds incorporating aluminum chloride (AlCl₃), and sodium dodecyl sulphate (C₁₂H₂₅NaO₄S) in a mono ethylene glycol solution. More specifically, in one form, the RTIL is 1-Butyl-3-methylimidazolium chloride ([BMIm]Cl), 1-Ethyl-3-methylimidazolium chloride ([EMIm]Cl) incorporating Aluminum Chloride (AlCl₃), and Sodium dodecyl sulphate (C₁₂H₂₅NaO₄S) in a glycol solution. The glycol solution is a suspension of 0.1 molar Ethylene glycol (C₂H₆O₂), solvated with Dichloromethane (CH₂Cl₂), in one form of the present disclosure. It should be understood, however, that different solutions may be employed while remaining within the teachings of the present disclosure.

In one form of the present disclosure, each compound of the ionic liquid 12 is provided in the following amounts:

TABLE 1
Ionic Liquid Composition Ranges

| | Mass |
|---|---|
| | percentage |
| Compound | (w/w) |
| 1-Butyl-3-methylimidazolium chloride ([BMIm]Cl) | 10% |
| 1-Ethyl-3-methylimidazolium chloride ([EMIm]Cl) | 60% |
| incorporating Aluminum Chloride (AlCl3) | |
| Sodium dodecyl sulphate (C12H25NaO4S) | 10% |

It should be understood that the ionic liquid 12 is not limited to the example composition above. Generally, the ionic liquid 12 includes the following parent molecular structure and formulations:

1-Butyl-3-methylimidazolium chloride ([BMIm]Cl)

1-butyl-3-methylimidazolium is a 1-alkyl-3-methylimidazolium in which the alkyl substituent at C-1 is butyl and can be represented by the chemical formula C₉H₁₅N₂+.

The structure for 1-Butyl-3-methylimidazolium with the inclusion of 1×[Cl—] (Chloride ion) can be represented by the chemical formula: C₉H₁₅ClN₂.

1-Ethyl-3-methylimidazolium chloride ([EMIm]Cl)

1-ethyl-3-methylimidazolium is a 1-alkyl-3-methylimidazolium in which the alkyl substituent at C-1 is ethyl and can be represented by the chemical formula: C₆H₁₁N₂+.

The structure for 1-Ethyl-3-methylimidazolium with the inclusion of 1×[Cl—] (Chloride ion) and can be represented by the chemical formula: C₆H₁₁ClN₂.

With the inclusion of aluminum chloride (aluminum ion), the structure can be represented by:

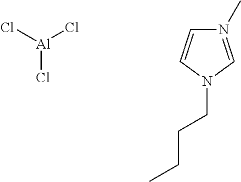

Further, the degradation pathway of ethane-1,2-diol>2-hydroxyacetaldehyde as shown below:

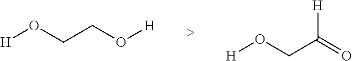

Thus, supporting and sustaining Al electrolysis in the presence of Irium (NaSO₄C₁₂H₂₅) as shown below:

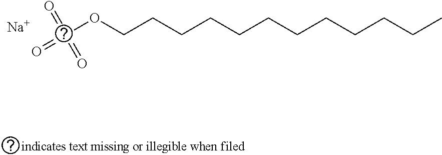

Accordingly, an Ethanol, 2-(dodecyloxy)-, hydrogen sulfate, sodium salt is created as the medium for ionic electrolytic plating incorporating methylimidazolium chloride and aluminum.

The anode 16 is aluminum, and more particularly in one form 99.99 wt. % aluminum. Alternately, the aluminum may be saturated in the ionic liquid 12 rather than having a discrete anode 16 as shown (i.e., the maximum amount of Aluminum Chloride (AlCl₃) is dissolved in the ionic liquid 12).

The power supply 18 generally provides current to the anode 16 at a level to control the rate of deposition of aluminum onto the substrate 19. In one form, the power supply 18 is an AC to DC twelve pulse rectifier (not shown). During the ionic electrolytic plating process, current is regulated from the power supply 18 by the AC to DC twelve pulse rectifier, in order to provide DC power, which results in a more consistent coating thickness. During the ionic electrolytic plating process, the temperature of the ionic liquid is maintained in a temperature range of about 288 Kelvin (59° F.) to about 305 Kelvin (89° F.). Further, the ionic liquid is agitated to maintain its activation.

In variations of the present disclosure, the substrate may be passivated after plating to remove free iron from its surface and thus inhibit corrosion. Further, coloration may be added during or after the ionic electrolytic plating so that the coating on the substrate has a predetermined color according to application specifications. In still another form, a thickness of the ionic plating is between about 5 μm and about 25 μm.

The ionic electrolytic plating process set forth above is now described in greater detail using a fastener, and more particularly a structural blind fastener, to which a friction coating is applied.

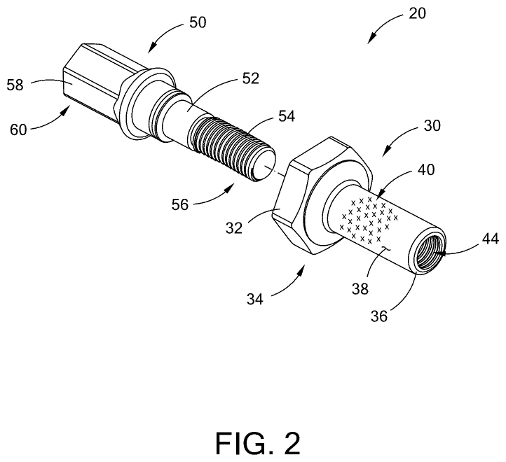

Referring to FIGS. 2-4, a structural blind fastener for joining a plurality of workpieces is illustrated and generally indicated by reference numeral 20. The structural blind fastener 20 is configured to join an upper workpiece 10 to a lower workpiece 12, wherein access to a distal face 14 of the lower workpiece 12 is “blind” or inaccessible to the user/installer/tool during installation of the structural blind fastener 20. It should be understood that more than two (2) workpieces may be joined with the structural blind fastener 20 according to the teachings herein, and as set forth in greater detail below, different types of structural fasteners other than the specific structural blind fastener illustrated and described herein should be construed as falling within the scope of the present disclosure. For example, the teachings herein may be applied to the structural blind fastener described in U.S. Pat. No. 11,143,226, which is commonly assigned with the present application and the contents of which are incorporated herein by reference in its entirety.

The structural blind fastener 20 in this form comprises a sleeve 30, which includes a tool engagement feature 32 disposed at a proximal end portion 34 of the sleeve 30. The tool engagement feature 32 may include, by way of example, a hex head (as shown) or a splined head, among others, and is generally configured to be engaged by a tool (not shown) for installation of the structural blind fastener 20 as described in greater detail below. It should be understood that the tool engagement feature 32 is optional and should not be construed as limiting the scope of the present disclosure.

As further shown, the sleeve 30 comprises a cylindrical outer wall 36 having an exterior surface 38, which comes into contact with the workpieces 10/12 after installation. The exterior surface 38 comprises a roughened area 40, which functions as a surface preparation, or an active surface, for subsequent coating as described in greater detail below. In one form, the roughened area 40 has an Ra of at least 0.4 μm, and in another form the Ra is at least 0.8 μm. As further shown, the roughened area 40 may be along a portion of the length of the exterior surface 38, or the roughened area 40 may extend along the entire length of the exterior surface 38 while remaining within the scope of the present disclosure. Generally, the roughened area 40 extends all the way around the periphery of the cylindrical outer wall 36 of the sleeve 30.

The sleeve 30 also comprises a central bore 42 extending along a length of the sleeve 30 and internal threads 44 disposed at a distal end portion 46 of the sleeve 30. The central bore 42 is configured to receive a bolt 50 as shown. The bolt 50 includes a shaft 52 extending through the central bore 42 of the sleeve 30. The shaft 52 comprises external threads 54 disposed at a distal end portion 56 of the bolt 50, and the external threads 54 are configured to engage the internal threads 44 of the sleeve 30 for installation. The bolt 50 further comprises a tool engagement feature 58 disposed at a proximal end portion 60 of the bolt 50, which is used during installation as described in greater detail below.

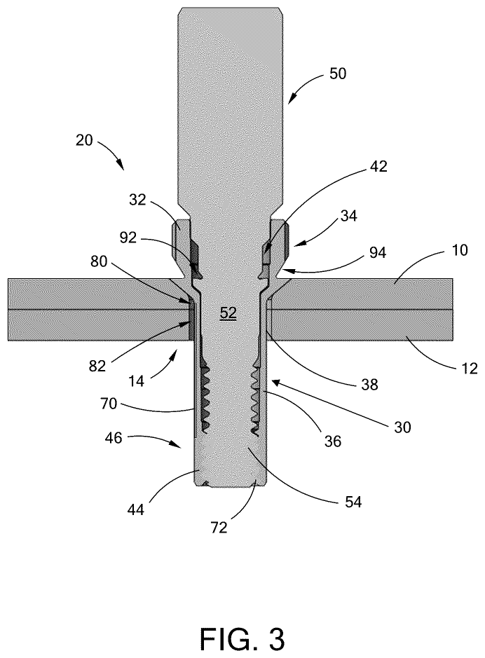

Referring specifically to FIG. 3, in one variation of the present disclosure, the sleeve 30 comprises one or more axial grooves 70 disposed along the exterior surface 38 of the sleeve. The axial grooves 70 are configured to allow for extrusion of excess sealant during installation of the structural blind fastener 20 when a sealant is specified for a particular application/installation. These axial grooves 70 extend along the portion of the exterior surface 38 that axially overlaps with the workpieces 10/12 and, as shown in the example provided, may extend beyond the distal face 14. As further shown, an optional self-locking adhesive 72 is disposed between the internal threads 44 of the sleeve 30 and the external threads 54 of the bolt 50. The self-locking adhesive 72 further secures the bolt 50 to the sleeve 30 after installation and resists unthreading, or antirotation, of the structural blind fastener 20 due to vibrations or other loading during service.

As set forth above, the exterior surface 38 of the sleeve 30 comprises the roughened area 40, which in one form is roughened by laser ablation. This surface roughening ablates the exterior surface 38 and thus provides an active surface for improved chemical bonding of the surface coating. The laser ablation also cleans the exterior surface 38 and provides a geometry with an increased surface area, thereby improving adhesion of the coating and friction during installation as described in greater detail below. While laser ablation is used in one form, it should be understood that other methods for roughening the exterior surface 38 of the sleeve can be employed while remaining within the scope of the present disclosure. Alternative methods include, by way of example, hybrid laser/water ablation, mechanical ablation (e.g., dry blasting), and/or chemical ablation.

Advantageously, as a result of the innovative friction coating for fasteners and method disclosed herein, conversion coatings or strike layers are not required to further inhibit corrosion, thereby improving the cost savings provided by the structural blind fastener 20 disclosed herein. Further, the friction coating provides an electrically conductive path from the structural blind fastener 20 to the workpieces 10/12 (when the structural blind fastener 20 and the workpieces 10/12 are themselves an electrically conductive material), thereby providing a direct path for lightning strike dissipation.

The 99.99 wt. % Al friction coating is applied with the electrodeposition process in a specific thickness that is a function of the material and size of the structural blind fastener 20 (both diameter and grip length) as well as the thickness and materials of the workpieces 10/12. In one form, the 99.99 wt. % Al friction coating has a thickness of about 3-5 μm. However, it should be understood that a variety of coating thicknesses and patterns may be employed while remaining within the scope of the present disclosure.

In one form, the workpieces 10/12 are an aluminum alloy material (e.g., 7075, 6061, among others), and the sleeve 30 is a 304 type stainless steel. With this combination of materials, the 99.99 wt. % Al applied onto the roughened surface 40 functions to increase friction between the sleeve 30 and the workpieces 10/12, thereby providing improved bonding to the Al workpieces 10/12 without any pretreatment thereof. More specifically, because the workpieces are an aluminum alloy material and the coating is 99.99 wt. % Al, the friction coefficient between the two materials is similar, thereby increasing friction during installation. Additionally, because the 99.99 wt. % Al coating follows the profile of the roughened surface 40, a further improved friction interface is formed between the exterior surface 38 of the sleeve and the workpieces 10/12.

### Installation

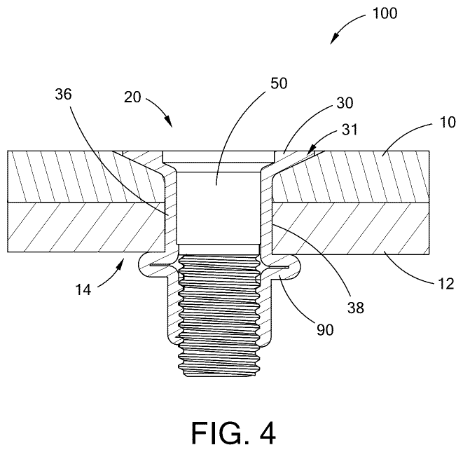

With reference to FIGS. 3 and 4, to install the structural blind fastener 20 and fasten the workpieces 10/12 together, the structural blind fastener 20 is first inserted into aligned apertures or holes 80 formed through the workpieces 10/12. Next, the tool engagement feature 32 of the sleeve 30 is gripped, and the tool engagement feature 58 of the bolt 50 is engaged and rotated in a tightening direction. When the bolt 50 is rotated in the tightening direction while the bolt 50 and sleeve 30 are held axially stationary, the threads 44/54 impart an axial force on the sleeve 30 to move the distal end portion 46 of the sleeve 30 toward the workpieces 10/12, causing the distal end portion 46 of the sleeve 30 to deform. Since the central bore 42 of the sleeve 30 is equal to or only slightly greater in diameter than the shaft 52 and the major diameter of the external threads 54 of the bolt 50, the distal end portion 46 of the sleeve 30 deforms radially outwards to form a bulb 90. The bulb 90 contacts the distal face 14 of the lower workpiece 12 and imparts a compressive force thereon that biases the lower workpiece 12 toward the upper workpiece 10. Thus, the workpieces 10/12 are secured between the bulb 90 and a head 31 of the sleeve 30. While the head 31 is shown as tapered or countersunk, it should be understood that any type of head (e.g., protruding) may be employed while remaining within the scope of the present disclosure.

Once the bulb 90 is formed, additional torque applied to the bolt 50 above a first predetermined torque threshold value can then cause a first frangible portion 92 to break. Similarly, torque can be applied to the sleeve 30 to cause a second frangible portion 94 to break, resulting in a flush upper surface as shown. As a result, a structural assembly 100 is formed, which comprises the workpieces 10/12 and the remaining portion of the structural blind fastener 20.

During rotation of the tool engagement feature 32 of the sleeve 30, the sleeve remains substantially rotationally stationary because of the 99.99 wt. % Al friction coating as described herein. Further, with aluminum alloy workpieces 10/12, the interface between the structural blind fastener 20, and more specifically the sleeve 30 and the 99.99 wt. % Al friction coating and the aluminum alloy workpieces 10/12 provides an antirotation function and is also effective against corrosion, while also providing an electrically conductive path as set forth above. Therefore, the innovative friction coating and surface preparation described herein provides a number of benefits (e.g., antirotation, conductive path, inhibiting corrosion) with a specific combination of materials for the workpieces 10/12 and the sleeve 30 of the structural blind fastener 20.

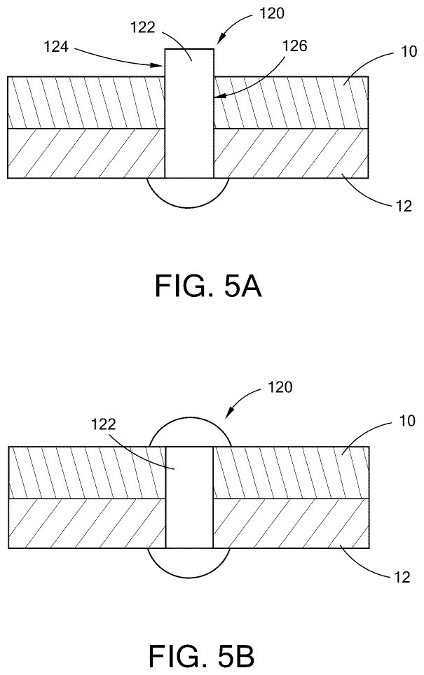

Referring now to FIGS. 5A and 5B, another form of a structural fastener having the 99.99 wt. % Al friction coating is illustrated and generally indicated by reference numeral 120. Similar to the structural blind fastener 20 described above, the structural fastener 120 comprises a body 122 with a cylindrical outer wall 124 having an exterior surface 126 configured to contact a plurality of workpieces 10/12 within bores defined by those workpieces 10/12. The exterior surface 126 includes the friction coating described above, consisting of 99.99 wt. % Aluminum (Al) applied onto a roughened surface (not shown), wherein the friction coating is applied using electrodeposition with a room temperature ionic liquid (RTIL) as set forth herein. Those familiar with structural fasteners will appreciate that this particular structural fastener 120 is an otherwise generic rivet, which may include a variety of features as a function of its specific installation. These features are not included herein for purposes of clarity.

The various features and processing specifics illustrated and described herein may be employed with this structural fastener 120, or any other structural fastener, either individually or in any combination while remaining within the scope of the present disclosure. The structural fastener 120 is illustrated as an example to demonstrate that the teachings herein may be applied to any type of fastener, whether installed with rotation or merely axial vibration, in which friction between the structural fastener and the workpieces 10/12 is desired, while remaining within the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of applying a coating to a substrate, the method comprising:
ionic electrolytic plating a substrate immersed within an ionic liquid at ambient temperature, in ambient air, and at ambient pressure with aluminum, wherein:
the ionic liquid comprises imidazolium chloride compounds having aluminum chloride (AlCl₃) and sodium dodecyl sulphate (C₁₂H₂₅NaO₄S) in a mono ethylene glycol solution, and
a deposition rate of the ionic electrolytic plating is controlled by a power supply and within a temperature range between about 288 Kelvin (59° F.) to about 305 Kelvin (89° F.).

2. The method according to claim 1, wherein the aluminum is an anode consisting of 99.99 wt. % aluminum.

3. The method according to claim 1, wherein the aluminum is saturated in the ionic liquid.

4. The method according to claim 1, wherein the power supply comprises an AC to DC twelve pulse rectifier.

5. The method according to claim 1, wherein the ionic liquid comprises:
1-Butyl-3-methylimidazolium chloride ([BMIm]Cl), 1-Ethyl-3-methylimidazolium chloride ([EMIm]Cl) incorporating Aluminum Chloride (AlCl₃), and Sodium dodecyl sulphate (C₁₂H₂₅NaO₄S).

6. The method according to claim 1, wherein an exterior surface of the substrate is roughened prior to the ionic electrolytic plating.

7. The method according to claim 6, wherein laser ablation is used to roughen the exterior surface.

8. The method according to claim 6, wherein the exterior surface is roughened to an Ra of at least 0.4 μm.

9. The method according to claim 1, wherein the substrate is a material selected from the group consisting of stainless steel, steel, aluminum, titanium, alloys thereof, polymers and fiber-reinforced polymers.

10. The method according to claim 1, wherein the substrate is a structural fastener.

11. The method according to claim 1, further comprising passivating the substrate after the ionic electrolytic plating.

12. The method according to claim 1, further comprising adding coloration during or after the ionic electrolytic plating.

13. The method according to claim 1, wherein a thickness of the ionic plating is between about 5 μm and about 25 μm.

14. A structural blind fastener for joining a plurality of workpieces, the structural blind fastener comprising:
a sleeve comprising:
a tool engagement feature disposed at a proximal end portion of the sleeve;
a cylindrical outer wall having an exterior surface, the exterior surface comprising a roughened area having an Ra of at least 0.4 μm and a friction coating consisting of 99.99 wt. % Aluminum (Al) applied onto the roughened area according to the method of claim 1; and
a central bore extending along a length of the sleeve, the central bore defining internal threads disposed at a distal end portion of the sleeve; and
a bolt including a shaft extending through the central bore of the sleeve, the shaft comprising external threads disposed at a distal end portion of the bolt, the external threads configured to engage the internal threads of the sleeve, wherein the bolt further comprises a tool engagement feature disposed at a proximal end portion of the bolt.

15. A structural assembly comprising:
a plurality of workpieces; and
a structural blind fastener according to claim 14.
